(19) United States
(12) Patent Application Publication
(10) Pub. No.: US 2023/0183455 A1
(43) Pub. Date: Jun. 15, 2023

(54) POLYMER COMPOSITIONS HAVING REDUCED ODOR EMISSIONS

(71) Applicant: SABIC Global Technologies B.V., Bergen op Zoom (NL)

(72) Inventors: Tianhua DING, Bangalore (IN); Jonathon SCHOLIN, Bangalore (IN); Nitin CHOPRA, Bangalore (IN)

(21) Appl. No.: 17/925,440

(22) PCT Filed: Jun. 9, 2021
(86) PCT No.: PCT/EP2021/065535

§ 371 Date: Nov. 15, 2022

Related U.S. Application Data
(60) Provisional application No. 63/036,449, filed on Jun. 9, 2020.

(51) Int. Cl. C08K 9/06; C08J 3/215

(52) U.S. Cl. CPC C08K 9/06; C08J 3/215; C08K 2201/006; C08J 2323/12; C08J 2369/00; C08J 2455/02

(57) ABSTRACT

The invention is directed to a polymer composition having reduced odor emission. The polymer composition comprises a plurality of functionalized silicate particles dispersed in a polymer component. The invention further describes a process for preparing the polymer composition involving either a compounding process or a masterbatch process. In addition, the invention further describes an automobile component comprising the polymer composition of the present invention or articles, which are prepared by injection molding or extrusion of the polymer composition of the present invention.

### CROSS REFERENCE TO RELATED APPLICATIONS

None.

### FIELD OF INVENTION

The present invention is directed to polymer compositions having reduced odor emissions.

### BACKGROUND

Drawbacks associated with odors originating from polymers/plastics have been gaining much needed attention as original equipment manufacturers (OEMs) and consumers seek improved air quality and safety of polymer raw materials, typically used for manufacturing consumer durables and industrial components. Numerous surveys have indicated that consumers and industry practitioners have a growing concern with chemical emissions from plastics, which may adversely affects health but also affects consumer satisfaction when such plastic products are used as components in various applications across industries. For example in the automotive industry, such chemical odor emissions, once idealized as the “new car smell” are no longer attractive to many consumers and therefore, driven by consumer requirements and market trends, there is a demand from the industry practitioners to develop or use low odor polymer materials in various automobile components.

While several processing and technical solutions have been explored in recent years to lower the odor score (odor emission) of polymers, incumbent technologies such as steam stripping, odor-maskers and adsorbent additives, have been found to be relatively inefficient for targeting and removing odor-active compounds or in some instances such technical solutions have required additional processing equipment, which increases both the complexity and cost of production. For example, although the use of polymer compositions having odor reducing additives have yielded promising results, the use of such additives does create formulation challenges of balancing additive loading along with product performance and retention of inherent polymer properties (e.g. physical, mechanical, etc.).

In addition it was observed that some of the current odor reducing additives, although partly effective, interfere with the performance of other low molecular weight species (anti-oxidants and stabilizers), typically present in any polymer formulations, thereby impeding the performance of these polymer formulations. On the other hand, the use of odor masking additives such as terpenes or synthetic oils have in many instances been perceived by consumers to be deceitful, since the actual polymer odor is simply diluted by the fragrance of the odor maskers instead of removing the odor active compounds completely. In addition, the use of odor reducing additives in polymer formulations have certain technical limitations such as low thermal stability, thereby limiting processability of the polymer compositions under high temperature conditions typically employed during molding. Additionally, in some instances the odor reducing additives induce polymer discoloration, resulting in reduced aesthetic appeal, which in turn results in the polymer composition not meeting consumer specification and requirement.

Thus, for the foregoing reasons, there remains a need for developing polymer compositions having reduced odor emissions while retaining one or more benefits of excellent polymer processability, desired thermal stability and suitable aesthetic property by preventing discoloration.

### BRIEF SUMMARY

The invention relates to a polymer composition, comprising: (a) a plurality of functionalized silicate particles, wherein each of the plurality of functionalized silicate particles is functionalized by a grafting compound; and (b) a polymer component, wherein the plurality of functionalized silicate particles are dispersed in the polymer component. In some embodiments of the invention, the functionalized silicate particle is selected from the group consisting of phyllosilicates, tectosilicates, nesosilicates, sorosilicates, cyclosilicates, inosilicates, or combinations thereof. In some embodiments of the invention, each of the plurality of functionalized silicate particle is a phyllosilicate or a tectosilicate selected from kaolins, micas, smectites, hormites, zeolites or combinations thereof. In some embodiments of the invention, each of the plurality of functionalized silicate particle is a phyllosilicate selected from phillipsite, talc, saponite, hectorite, montmorillonite, nontronite, beidellite, palygorskite, sepiolite, kaolinite, halloysite, muscovite, illite or combinations thereof. In some embodiments of the invention, each of the plurality of functionalized silicate particles is a zeolite particle selected from mordenite, clinoptilolite, chabazite or combinations thereof.

In some embodiments of the invention, each of the plurality of functionalized silicate particles is functionalized by at least one functional group capable of reacting with one or more odor active compound and forming a condensate reaction product. In some embodiments of the invention, the odor active compound is an organic compound having a functional group selected from aldehydes, thiols, esters, amines, ketones, carboxylates, alcohols, aromatics, or combination thereof. In some embodiments of the invention, the grafting compound is selected from aminosilane compounds, mercaptosilane compounds, carboxylated silane compounds, epoxy silane compounds, amine compounds, thiol compounds, organic acid compounds or combination thereof. In some preferred embodiments of the invention, the grafting compound is an aminosilane compound selected from (3-aminopropyl) triethoxysilane.

In some embodiments of the invention, the polymer component is selected from a thermoplastic polymer, a thermoset polymer, an elastomeric polymer or combinations thereof. In some preferred aspects of the invention, the polymer component is a thermoplastic polymer. In some aspects of the invention, the polymer component is selected from polypropylene (PP), polyethylene, polyester, polycarbonate, polyetherimide (PEI), polyethyleneimine, styrene-acrylonitrile resin (SAN), polyvinyl chloride (PVC), epoxy polymers, polyether ether ketone (PEEK), poly(phenylene oxide) (PPO), polyether ketone ketone (PEKK), polysulfone sulfonate (PSS), polyphenylene sulfide (PPS), sulfonates of polysulfones, thermoplastic elastomer (TPE), terephthalic acid (TPA) elastomers, acrylonitrile butyldiene styrene (ABS), poly(methyl methacrylate) (PMMA), blend of polycarbonate and polybutylene terephthalate (PBT), blend of polycarbonate-acrylonitrile butadiene styrene (ABS), elastomeric block co-polymers, blend of polycarbonate-polyethylene terephthalate (PET), polyamide, polystyrene (PS) or combinations thereof.

In some embodiments of the invention, the plurality of functionalized silicate particles are present in an amount ranging from 0.01 wt. % to 65.0 wt. %, with regard to the total weight of the polymer composition. In some preferred embodiments of the invention, the plurality of functionalized silicate particles are present in an amount ranging from 0.1 wt. % to 20.0 wt. %, with regard to the total weight of the polymer composition. In some embodiments of the invention, the polymer component is present in an amount ranging from 35.0 wt. % to 99.99 wt. %, with regard to the total weight of the polymer composition. In some preferred embodiments of the invention, the polymer component is present in an amount ranging from 80.0 wt. % to 99.90 wt. %, with regard to the total weight of the polymer composition. In some embodiments of the invention, the polymer composition further comprises additives ranging from 0 wt. % to 55.0 wt. % with regard to the total weight of the polymer composition.

In some preferred embodiments of the invention, each of the plurality of functionalized silicate particle contains a grafting compound present in an amount ranging from 1.0 wt. % to 30.0 wt. %, with regard to the total weight of the functionalized silicate particle. In some embodiments of the invention, each of the plurality of functionalized silicate particle has a surface area of at least 100 m²/g. In some embodiments of the invention, each of the plurality of functionalized silicate particle has a surface area ranging from 110 m²/g to 1000 m²/g.

In some aspects of the invention, the invention is directed to a process for preparing the polymer composition of the present invention, comprising (a) providing a polymer component; (b) providing a plurality of functionalized silicate particles; and (c) compounding a mixture comprising the polymer component and the plurality of functionalized silicate particles and forming the polymer composition.

In some aspects of the invention, the invention is directed to a process for preparing the polymer composition of the present invention, comprising (a) dissolving a polymer binder component in a solvent and forming a polymer solution; (b) dispersing a plurality of functionalized silicate particles in a solvent and forming a silicate dispersion; (c) adding the silicate dispersion to the polymer solution at any temperature ranging between 10° C. to 500° C. and forming a masterbatch precursor; (d) subjecting the masterbatch precursor to precipitation conditions and obtaining a masterbatch comprising a plurality of functionalized silicate particles; and (e) compounding the masterbatch with a polymer component and obtaining the polymer composition.

In some aspects of the invention, the invention is directed to an automobile component comprising the polymer composition of the present invention. In some embodiments of the invention, the invention is directed to a polymeric article prepared by injection molding or by extruding the polymer composition of the present invention.

In some aspects of the invention, the invention is directed to a polymer composition, comprising: (a) a plurality of functionalized zeolite particles present in an amount ranging from 0.01 wt. % to 65.0 wt. % with regard to the total weight of the polymer composition, wherein each of the plurality of zeolite particles is functionalized by an aminosilane compound containing at least one amine functional group; and (b) a thermoplastic polymer component present in an amount ranging from 35.0 wt. % to 99.99 wt. %, with regard to the total weight of the polymer composition, wherein the plurality of functionalized zeolite particles are dispersed in the thermoplastic polymer component.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

For a more complete understanding, reference is now made to the following descriptions taken in conjunction with the accompanying drawings, in which:

FIG. 1 is a schematic representation in accordance with an embodiment of the invention, of a chemical reaction between an amine functionalized mordenite silicate particle and a carbonyl group containing odor active compound such as acetaldehyde, to form a condensate product, containing an imine group.

FIG. 2 is an FTIR-ATR spectra of nonanal (blue), mordenite-g-NH2 (purple), and imine product formed between nonanal and mordenite-g-NH2 (red).

### DETAILED DESCRIPTION OF THE INVENTION

The invention, is based, in part, on a polymer composition having reduced odor emissions while retaining the desired key properties of the polymer itself. The polymer composition of the present invention comprises a plurality of functionalized silicate particles, which is dispersed in a polymer and have the property of reducing the concentration of odor active compounds present in polymer. In particular, the functionalized silicate particles are advantageous as it has dual functionality: first, the functional group (e.g. amine group) assists in scavenging odor active compounds, thereby improving the odor score of the polymer: and second, the inherent high surface area and/or porosity of the silicate particles assists in adsorbing the odor active compounds, resulting in further reduction in odor emissions.

The following includes definitions of various terms and phrases used throughout this specification.

The terms “wt. %”, “vol. %” or “mol. %” refers to a weight, volume, or molar percentage of a component, respectively, based on the total weight, the total volume, or the total moles of the material that includes the component. In a non-limiting example, 10 moles of a component in 100 moles of the material means 10 mol. % of the component. The term “M” refers to a molar concentration of a component, based on the moles per 1 L volume. The term “mM” means one thousandth of an “M”. Any numerical range used through this disclosure shall include all values and ranges there between unless specified otherwise. For example, a boiling point range of 50° C. to 100° C. includes all temperatures and ranges between 50° C. and 100° C. including the temperature of 50° C. and 100° C.

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.” The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The process of the present invention can “comprise”, “consist essentially of,” or “consist of” particular ingredients, components, compositions, etc., disclosed throughout the disclosure.

The expression “plurality of functionalized silicate particles” as used herein means multiple individual functionalized silicate particles, each of which is dispersed in the polymer component. The expression “polymer component” as used throughout this disclosure means a polymer matrix or a polymer substrate in which the individual functionalized silicate particles are dispersed. The expression “functionalized silicate” as used throughout this disclosure means, silicate particles, which are surface modified chemically by attaching a grafting compound containing a reactive functional group, wherein the attachment can be by means of a covalent bond, ionic bond, hydrogen bonding and any other suitable attachment. The expression “odor active compound” means compounds including but not limited to volatile organic compounds, which induce odor in polymer material.

In some aspects of the invention, the invention relates to a polymer composition, comprising: (a) a plurality of functionalized silicate particles, wherein each of the plurality of functionalized silicate particles is functionalized by a grafting compound; and (b) a polymer component, wherein the plurality of functionalized silicate particles are dispersed in the polymer component. In some embodiments of the invention, the functionalized silicate particle is selected from the group consisting of phyllosilicates, tectosilicates, nesosilicates, sorosilicates, cyclosilicates, inosilicates, or combinations thereof. In some embodiments of the invention, each of the plurality of functionalized silicate particle is a phyllosilicate or a tectosilicate selected from kaolins, micas, smectites, hormites, zeolites or combinations thereof. In some preferred aspects of the invention, the functionalized silicate particle is a tectosilicate and is a zeolite particle. In some embodiments of the invention, each of the plurality of functionalized silicate particle is a phyllosilicate selected from kaolins, micas, smectites, hormites or combinations thereof. In some embodiments of the invention, each of the plurality of functionalized silicate particle is a phyllosilicate selected from phillipsite, talc, saponite, hectorite, montmorillonite, nontronite, beidellite, palygorskite, sepiolite, kaolinite, halloysite, muscovite, illite or combinations thereof. In some embodiments of the invention, each of the plurality of functionalized silicate particles is a zeolite particle selected from mordenite, clinoptilolite, chabazite, or combinations thereof. In some preferred embodiments of the invention, the functionalized silicate particle is mordenite.

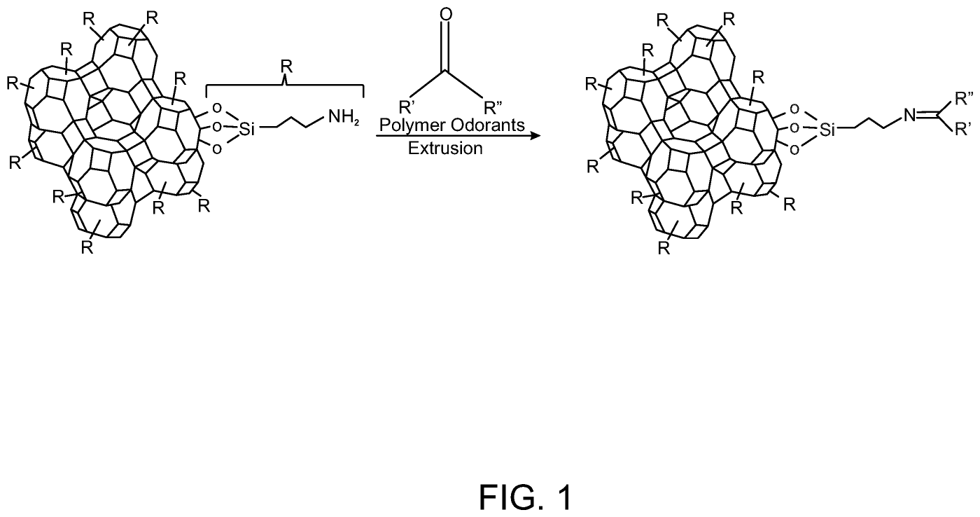

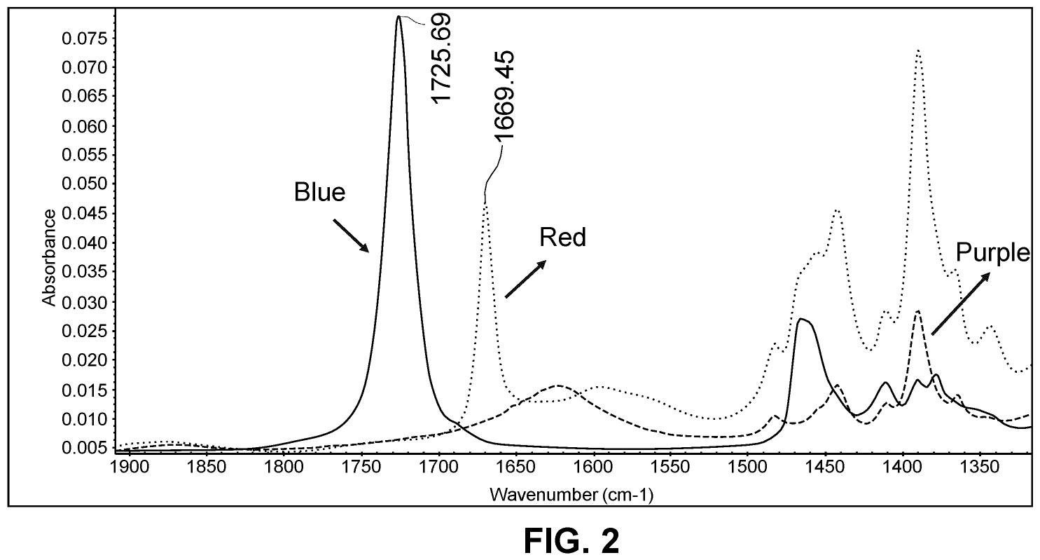

In some embodiments of the invention, each of the plurality of functionalized silicate particles is functionalized by at least one functional group capable of reacting with one or more odor active compound and forming a condensate reaction product. In some embodiments of the invention, the odor active compound is an organic compound having a functional group selected from aldehydes, thiols, esters, amines, ketones, carboxylates, alcohols, aromatics, or combination thereof. In preferred embodiments of the invention, the functional group is an amine. Although the invention demonstrates by way of working examples the use of amine-functionalized silicate to remove aldehydes, the amine functional group can also be used to target other high intensity odor-active oxygenate species including carboxylic acids, ketones, or alcohols found in polyolefin or engineering thermoplastics (ETP) and other polymeric material. Without wishing to be bound by any specific theory, it is believed that the functional group reacts with an odor active compound to form a condensate reaction product resulting in the removal of the odor characteristic from the polymer. Therefore, it may be appreciated by a skilled person that unlike odor masking agents, such as oil and fragrance, the solution provided by way of the present invention imparts significant removal of the odor active compounds brought about by chemically reacting the odor reactive compound and the functional group of functionalized silicate particle. FIG. 1 provides a schematic representation of an amine functional group that may react with an odor causing carbonyl compound to form an imine product. FIG. 2 provides a spectral graph, evidencing the formation of an imine bond during the reaction between an amine functional group present on the surface of the silicate particle and a carbonyl containing (aldehyde group) compound present as an odor active compound.

In some aspects of the invention, the functional group on the silicate particle can be tuned to target specific compounds. For example, non-limiting examples of tuning functional groups to target specific odorants include amine-functionality to scavenge vinyl compounds, epoxy-functionality to scavenge organic acid compounds, or mercapto-functionality to scavenge aromatic compounds. In some embodiments of the invention, the grafting compound is selected from aminosilane compounds, mercaptosilane compounds, carboxylated silane compounds, epoxy silane compounds, amine compounds, thiol compounds, organic acid compounds or combination thereof. In some preferred embodiments of the invention, the grafting compound is an aminosilane compound selected from (3-aminopropyl) triethoxysilane. In some preferred embodiments of the invention, each of the plurality of functionalized silicate particles, contains a grafting compound present in an amount ranging from 1.0 wt. % to 30.0 wt. %, alternatively from 3.0 wt. % to 20.0 wt. %, alternatively from 5.0 wt. % to 15.0 wt. %, or alternatively from 8.0 wt. % to 10.0 wt. %, with regard to the total weight of the functionalized silicate particle. The amount of grafting compound may be suitably tuned depending on the type and concentration of the odor active compound that needs to be scavenged.

In some embodiments of the invention, the silicate particles are further engineered to have suitable surface area to enable the odor active compounds to be adsorbed in the pores of the functionalized silicate particle and thereby such silicate particles provide an alternative mechanism of odor reduction from the polymer component. In some embodiments of the invention, each of the plurality of functionalized silicate particle has a surface area of at least 100 m²/g, alternatively at least 300 m²/g, alternatively at least 400 m²/g, alternatively at least 450 m²/g, or alternatively at least 550 m²/. In some embodiments of the invention, each of the plurality of functionalized silicate particle has a surface area ranging from 110 m²/g to 1000 m²/g, alternatively ranging from 300 m²/g to 800 m²/g, alternatively from 400 m²/g to 600 m²/g, or alternatively from 450 m²/g to 550 m²/g. For the purposes of the present invention, the surface area may be determined by measuring nitrogen adsorption according to the Brunauer, Emmett and Teller (BET) method. The BET experiment was carried out by using Quantachrome Autosorb®-6iSA.

In some embodiments of the invention, the polymer component is selected from a thermoplastic polymer, a thermoset polymer, an elastomeric polymer or combinations thereof. In some preferred aspects of the invention, the polymer component is a thermoplastic polymer. In some preferred embodiments of the invention, the polymer component is a thermoset polymer. In some preferred embodiments of the invention, the polymer component is an elastomeric polymer. In some aspects of the invention, the polymer component is selected from polypropylene (PP), polyethylene (PE), polyester, polycarbonate (PC), polyetherimide (PEI), polyethyleneimine, styrene-acrylonitrile resin (SAN), polyvinyl chloride (PVC), epoxy polymers, polyether ether ketone (PEEK), poly(phenylene oxide) (PPO), polyether ketone ketone (PEKK), polysulfone sulfonate (PSS), polyphenylene sulfide (PPS), sulfonates of polysulfones, thermoplastic elastomer (TPE), terephthalic acid (TPA) elastomers, acrylonitrile butyldiene styrene (ABS), poly(methyl methacrylate) (PMMA), blend of polycarbonate and polybutylene terephthalate (PBT), blend of polycarbonate-acrylonitrile butadiene styrene (ABS), elastomeric block co-polymers, blend of polycarbonate-polyethylene terephthalate (PET), polyamide, polystyrene (PS) or combinations thereof. In some preferred embodiments of the invention, the polymer component is polypropylene or copolymers or blends thereof. In some preferred embodiments of the invention, the polymer component is selected from a blend of polycarbonate and polybutylene terephthalate (PBT), a blend of polycarbonate-acrylonitrile butadiene styrene (ABS), a blend of polycarbonate-polyethylene terephthalate (PET). In some embodiments of the invention, the polypropylene is a heterophasic polypropylene.

Non-limiting examples of polyethylene polymer that may be used for the purpose of the invention are linear low density polyethylene, low density polyethylene, and high density polyethylene. Non-limiting examples of polyester that may be used for the purpose of the invention are polyethylene terephthalate (PET), polybutylene terephthalate (PBT), poly(1,4-cyclohexylidene cyclohexane-1,4-dicarboxylate) (PCCD), glycol modified polycyclohexyl terephthalate (PCTG), poly(cyclohexanedimethylene terephthalate) (PCT), and polyethylene naphthalate (PEN).

In some embodiments of the invention, the plurality of functionalized silicate particles are present in an amount ranging from 0.01 wt. % to 65.0 wt. %, alternatively in an amount ranging from 0.1 wt. % to 20.0 wt. %, alternatively from 1.0 wt. % to 15.0 wt. %, or alternatively from 5.0 wt. % to 10.0 wt. %, with regard to the total weight of the polymer composition. In some embodiments of the invention, the polymer component is present in an amount ranging from 35.0 wt. % to 99.99 wt. %, alternatively from 80.0 wt. % to 99.90 wt. %, alternatively from 85.0 wt. % to 99.0 wt. %, or alternatively from 90.0 wt. % to 95.0 wt. %, with regard to the total weight of the polymer composition.

In some preferred embodiments of the invention, the invention is directed to a polymer composition comprising (a) a plurality of functionalized silicate particles present in an amount ranging from 0.01 wt. % to 65.0 wt. %, alternatively in an amount ranging from 0.1 wt. % to 20.0 wt. %, alternatively from 1.0 wt. % to 15.0 wt. %, or alternatively from 5.0 wt. % to 10.0 wt. %, with regard to the total weight of the polymer composition, wherein each of the plurality of functionalized silicate particles is functionalized by a grafting compound; and (b) a polymer component present in an amount ranging from 35.0 wt. % to 99.99 wt. %, alternatively from 80.0 wt. % to 99.90 wt. %, alternatively from 85.0 wt. % to 99.0 wt. %, or alternatively from 90.0 wt. % to 95.0 wt. %, with regard to the total weight of the polymer composition, wherein the plurality of functionalized silicate particles are dispersed in the polymer component.

In some embodiments of the invention, the polymer composition further comprises additives ranging from 0 wt. % to 55.0 wt. %, alternatively from 0 wt. % to 40.0 wt. %, alternatively from 0.1 wt. % to 35.0 wt. %, alternatively from 2.0 wt. % to 25.0 wt. %, alternatively from 5.0 wt. % to 15.0 wt. %, with regard to the total weight of the polymer composition. Non-limiting examples of additives include non-odor reducing additives such as glass fiber, reinforcing fibers, color additives, anti-oxidants, light stabilizers, acid scavengers, salt additives, fire retardants, plasticizers, compatibilizers, and anti-blocking agents. In some preferred embodiments of the invention, the invention is directed to a polymer composition comprising (a) a plurality of functionalized silicate particles present in an amount ranging from 0.01 wt. % to 65.0 wt. %, with regard to the total weight of the polymer composition, wherein each of the plurality of functionalized silicate particles is functionalized by a grafting compound; (b) a polymer component present in an amount ranging from 35.0 wt. % to 99.99 wt. % with regard to the total weight of the polymer composition; and (c) additives ranging from 0 wt. % to 55.0 wt. % with regard to the total weight of the polymer composition, wherein the additives and/or the plurality of functionalized silicate particles are dispersed in the polymer component. In some preferred embodiments of the invention, the polymer component is polypropylene reinforced by glass fiber additives.

In some aspects of the invention, the invention is directed to a process for preparing the polymer composition of the present invention, comprising (a) providing a polymer component; (b) providing a plurality of functionalized silicate particles; and (c) compounding a mixture comprising the polymer component and the plurality of functionalized silicate particles and forming the polymer composition. In some embodiments of the invention, compounding of the mixture is carried out at any temperature between 10° C. and 500° C., alternatively between 20° C. and 300° C., or alternatively between 50° C. and 250° C. As may be appreciated by a skilled person, depending on the original concentration of odor active compound, the final concentration of the odor active compound is reduced to a suitable concentration for the polymer composition to be used in various industrial application while meeting a desired consumer specification on odor emissions.

An alternative approach to prepare the polymer composition of the present invention involves a masterbatch process. In some embodiments of the invention, the invention is directed to a process for preparing the polymer composition of the present invention, comprising (a) dissolving a polymer binder component in a solvent and forming a polymer solution; (b) dispersing a plurality of functionalized silicate particles in a solvent and forming a silicate dispersion; (c) adding the silicate dispersion to the polymer solution at any temperature ranging between 10° C. to 500° C., alternatively ranging between 20° C. to 350° C., alternatively ranging between 30° C. to 350° C. and forming a masterbatch precursor; (d) subjecting the masterbatch precursor to precipitation conditions and obtaining a masterbatch comprising a plurality of functionalized silicate particles; and (e) compounding the masterbatch with a polymer component and obtaining the polymer composition. Without wishing to be bound by any specific theory, it is believed that the polymer binder component ensures suitable compatibilization between the polymer component and the masterbatch to ensure suitable dispersion of the functionalized silicate particles. In some embodiments of the invention, the solvent used for preparing the polymer solution may be any suitable non-polar industrial solvent, such as xylene or toluene, where the polymer may be dissolved under constant stirring and optionally under heat. In some embodiments of the invention, the silicate dispersion may be formed by dispersing the plurality of functionalized silicate particles in a polar solvent such as ethanol followed by sonication. The silicate dispersion is added to the polymer solution at a suitable temperature depending on the Tg of the polymer, to prevent precipitation of the polymer.

In some aspects of the invention, the invention is directed to an automobile component comprising the polymer composition of the present invention. In some embodiments of the invention, the invention is directed to a polymeric article prepared by injection molding or by extruding the polymer composition of the present invention. Non-limiting examples of polymeric articles include films, automotive components, packaging material and consumer durable products.

In some aspects of the invention, the inventive polymer composition demonstrates a suitable odor score as determined by the technique prescribed under VDA 270 standards. In some embodiments of the invention, the odor score improvement of the polymer composition of the present invention, is at least 5.0%, alternatively at least 10.0%, alternatively at least 15.0%, over the odor score of a polymer composition without having functionalized silicate particles, wherein the odor score is measured in accordance with VDA 270. For clarification, improvement in odor score means a reduction in the value of the VDA 270 score, with 6 being the least desirable score and 1 being the most desirable score. Accordingly, an odor score, for example, of 1.0 is desirable over that of 2.5, which in turn a score of 2.5 is desirable over that of an odor score of 3 or 5.

Accordingly, the invention includes embodiments that describe polymer compositions having reduced odor emissions, while retaining one or more benefits of excellent polymer processability, desired thermal stability and suitable aesthetic property. Advantageously, the invention now enables artisans to use the polymer composition of the present invention as raw material, which can be injection molded or extruded into plastic components and used in many different applications including automotive components with the benefit of meeting customer specification of low odor emissions.

Specific examples demonstrating some of the embodiments of the invention are included below. The examples are for illustrative purposes only and are not intended to limit the invention. It should be understood that the embodiments and the aspects disclosed herein are not mutually exclusive and such aspects and embodiments can be combined in any way. Those of ordinary skill in the art will readily recognize parameters that can be changed or modified to yield essentially the same results.

### EXAMPLES

### Example I

Purpose: This example section demonstrates the performance of a polymer composition prepared in accordance with an embodiment of the present invention having reduced odor emissions. For the purpose of demonstrating the performance of the inventive polymer composition, amine grafted silicate particles (mordenite) (2.0 wt. %) and a polymer component comprising polypropylene (98.0 wt. %) were used. The performance of the inventive polymer composition was compared with performance of the control samples in terms of percentage reduction in odor active compound.

Materials: The table below provides a summary of the materials used for preparing the polymer composition for the purpose of the examples and the suppliers from whom the materials were procured:

TABLE 1
Material description

| Inventive Feature | Material | Supplier |
|---|---|---|
| Polymer component | Polypropylene | SABIC |
| | (Melt Flow Rate (MFR) 33 | |
| | g/10 min 260° C./2.16 kg) | |
| Silicate particle | Mordenite | Zeochem |
| Grafting compound | (3-aminopropyl) triethoxysilane | Sigma Aldrich |
| | (APTES) | |

Process for preparing functionalized silicate (mordenite) particles using an amino silane as the grafting compound: The process that was practiced was as follows, mordenite was dried in an oven at 105° C. for 16 hours to remove any absorbed water. The dried powder was taken in anhydrous ethanol to create a 5 to 50 wt. % dispersion. The solution was optionally heated in an oil bath at 60° C. for 30 minutes. To the dispersion, a desired amount of (3-Aminopropyl)triethoxysilane (APTES) was slowly added dropwise to the stirring mordenite dispersion and mixed at an ambient temperature or optionally at 60° C. for 0.5-2 hours. The mixture was filtered, washed with ethanol, and dried at 70° C. for 16 hours. The final material was lightly grounded with a mortar and pestle and stored in a sealed container at ambient temperature. Table 2 describes the material specifications before and after surface functionalization.

The particle size was measured using laser diffraction particle sizing by measuring the intensity of light scattering as a laser beam passes through a sample. For the purposes of this example, Malvern Mastersizer 3000 was used. The pore volume was determined by measuring nitrogen adsorption according to the Brunauer, Emmett and Teller (BET) method. The BET experiment was carried out by using a Quantachrome Autosorb®-6iSA. The surface area and pore volume was determined by measuring nitrogen adsorption according to the Brunauer, Emmett and Teller (BET) method. The BET experiment was carried out by using a Quantachrome Autosorb©-6iSA.

TABLE 2
Silicate characteristics before and after surface functionalization

| | Before | After |
|---|---|---|
| Appearance | White Powder | White Powder |
| Particle size (μm) | <10 | <10 |
| Specific surface area (m²/g) | 530 | 495 |
| Pore volume (cc/g) | 0.310 | 0.316 |
| Pore size (nm) | 0.234 | 0.255 |
| Aminosilane (wt. %) | 0 | 9.16 |

Process for preparing inventive polymer composition (IC) involving a compounding process: The general process to prepare the polymer composition for the purposes of the example involved the following process: (a) providing a polymer component having a predefined concentration of volatile organic compound; (b) providing a plurality of functionalized silicate particles; and (c) compounding a mixture comprising the polymer component and the plurality of functionalized silicate particles and forming the polymer composition.

In particular, the process that was practiced was as follows: into a glass container, polypropylene polymer (polymer component) was taken with a desired amount of nonanal (odor-active volatile organic compound) in an amount of 100 ppm. The vessel was tightly sealed and placed on a platform shaker at 200 rpm for 16 hours. Three grams of the polypropylene/nonanal sample and 2.0 wt. % of the functionalized mordenite particles (functionalized silicate particles) were added to an Xplore MC15 micro-compounder at 230° C. and mixed for 1 minute and the inventive polymer composition was formed.

The compounded material (polymer composition) was collected on a ceramic dish and quickly transferred to sealed headspace vials. The vials were conditioned at 80° C. for 30 minutes and sampled with a static headspace set-up to quantify nonanal emissions. The GC analysis conditions to detect nonanal were calibrated as follows: oven temperature program starts at 35° C. (5 min), then ramped up to 240° C. (10 min, 10° C./min), with inlet and FID detector temperature of 250° C., column flow rate 1.1 mL/min, injection volume 1 μL with split ratio of 10:1.

Preparation of reference samples: For the purpose of evaluating the performance of the inventive composition, the following reference samples (control) were prepared using the similar process as the inventive composition. The reference samples that were used are as described:

TABLE 3
Reference samples and their composition

| | Polymer Component | Odor reducing additive |
|---|---|---|
| Reference Sample 1 | Polypropylene (98 wt. %) | (3-Aminopropyl)triethoxysilane |
| | | (APTES) |
| | | (2.0 wt. %) |
| Reference Sample 2 | Polypropylene (98 wt. %) | Non-functionalized mordenite |
| | | (2.0 wt. %) |
| Reference Sample 3 | Polypropylene (98 wt. %) | (3-Aminopropyl) triethoxysilane |
| | | (APTES) (1.0 wt. %) |
| | | and |
| | | Non-functionalized mordenite |
| | | (1.0 wt. %) |

Results: The performance of the inventive composition and the reference samples are provided below under Table 4. The performance is evaluated based on the percentage reduction in nonanal concentration in the polymer composition after the addition of the odor reducing additives using gas chromatography (GC) head space analysis. The calculation is based on using the ratio of remaining nonanal in the polymer compared to the starting nonanal concentration in the polymer without the functionalized mordenite particles. For the purposes of the present example, the initial nonanal concentration (prior to the addition of any odor reducing additives) in the polymer was taken as 100 ppm by weight as reference standard to measure the reduction in nonanal.

TABLE 4
Silicate characteristics before and after surface functionalization

| | Percentage reduction |
|---|---|
| Sample Reference | in nonanal (%) |
| Inventive Polymer Composition | 97.7% |
| Reference Sample 1 | 83.2% |
| Reference Sample 2 | 67.4% |
| Reference Sample 3 | 53.5% |

From Table 4, it is evident that the inventive composition demonstrates significantly lower nonanal content compared to the reduction in nonanal content in the Reference Samples (1-3). The reduction of nonanal by nearly 98%, demonstrates that the odor active compound, is reduced to an amount sufficient for the inventive propylene composition to meet desired specification of reduced odor emissions. This finding is particularly unexpected in view of the results obtained for the composition of Reference Sample 3 in which both mordenite and the amine compound were added in the polypropylene as individual components to the polypropylene, rather than by surface functionalization of mordenite.

Reference Sample 3, not only demonstrates merely 50% lower nonanal reduction but also shows discoloration, which is particularly not desired in certain consumer application. It is therefore, evident that the surface functionalization of the mordenite particles impart synergistic property in terms of improving odor emission without discoloration. It is further evident from Reference Sample 2 data that mordenite particles on their own reduced the starting nonanal concentration by 67.4%, but if the mordenite particles are functionalized by an amine group, the resulting composition achieved an even higher reduction of 97.7%. In addition, it was observed that the mordenite particles imparted yellow color (discoloration) to an otherwise white-colored polypropylene resin while no such discoloration was observed with the functionalized mordenite particles.

From the results of Reference Sample 1, it was observed that the (3-Aminopropyl)triethoxysilane (APTES) functional unit did not cause any discoloration of the polymer and reduced nonanal by 83.2% confirming the utility of amine functional group to scavenge free aldehyde. However, the aminosilane compound (APTES) itself imparted a malodor, rendering it unsuitable for odor reduction applications on its own.

Thus, the inventive composition containing the functionalized mordenite and polypropylene exhibited superior performance in targeting a specific odor-active compound (i.e. nonanal) in polypropylene. Further evidence of the scavenging reaction was confirmed with FTIR-ATR spectroscopic technique. As shown in FIG. 2, the red IR spectrum of the functionalized mordenite, after reacting with nonanal, shows a sharp peak at 1669 cm¹, indicative of an imine C═N stretch which is not observed in the nonanal spectrum (blue) nor functionalized mordenite spectrum (purple).

### Example II

Purpose: This example section uses the VDA 270 odor test standard to evaluate the performance an inventive polymer composition against a set of comparative compositions.

Material used: The following materials were used as inventive and comparative examples.

TABLE 4
Reference samples and their composition

| | Polymer Component | Odor reducing additive |
|---|---|---|
| Inventive | Polycarbonate/Acrylonitrile | (3-Aminopropyl)triethoxysilane |
| Reference (IR) | Butadiene Styrene (PC/ABS) | (APTES) functionalized mordenite |
| | (98 wt. %) | (2 wt. %) |
| Comparative | Polycarbonate/Acrylonitrile | Non-functionalized mordenite |
| Reference 1 | Butadiene Styrene (PC/ABS) | (2 wt. %) |
| (CR1) | (98 wt. %) | |
| Comparative | Polycarbonate/Acrylonitrile | Not present |
| Reference 2 | Butadiene Styrene (PC/ABS) | |
| (CR2) | (100 wt. %) | |

Method of preparing the composition: The process for preparing the inventive and comparative formulations are as follows: 9.8 grams of PC/ABS obtained from SABIC and having Melt Flow Rate (MFR) of 8 g/10 min @ 260° C./2.16 kg, was co-fed with 0.2 grams of odor-reduction additive (APTES functionalized mordenite) into an Xplore MC15HT micro-compounder. The compound was mixed using 100 RPM screw speed for 1 minute at 280° C. The extrudate was immediately transferred to an Xplore IM12 to mold flex bars (ASTM D790A) at 80° C. and at a pressure of 10 bar for 10 seconds. The sample CR1 was prepared in a similar manner except that non-functionalized mordenite was used for preparing the composition.

Measurement standard: Odor testing was conducted at IMAT (Marietta, Ga., USA) following the standard in accordance with VDA 270 (Variant 3). Odor grades were reported as a rounded average of the score provided by three individual panelists. The VDA 270 odor standard/gradation is as shown below:

TABLE 5
VDA 270 odor gradation

| Grade | Evaluation Scale |
|---|---|
| Grade 1 | Not perceptible |
| Grade 2 | Perceptible, not disturbing |
| Grade 3 | Clearly perceptible, but not disturbing |
| Grade 4 | Disturbing |
| Grade 5 | Strongly disturbing |
| Grade 6 | Not acceptable |

Results: The results from the odor test is as shown below in accordance with VDA 270 standard:

TABLE 6
Odor test results

| | Odor | Panelist | Panelist | Panelist | Std. | |
|---|---|---|---|---|---|---|
| | Grade | No. 1 | No. 2 | No. 3 | Deviation | Odor Profile |
| Inventive | 2.5 | 2.5 | 2.5 | 2.5 | 0 | Perceptible, not |
| Reference | | | | | | disturbing |
| (IR) | | | | | | (Acceptable) |
| Comparative | 3.0 | 3.0 | 3.0 | 3.0 | 0 | Like Chlorine soap |
| Reference 1 | | | | | | (Not desirable) |
| (CR1) | | | | | | |
| Comparative | 3.0 | 3.0 | 3.0 | 3.0 | 0 | Varnish/Penetrative |
| Reference 2 | | | | | | (Not desirable) |
| (CR2) | | | | | | |

From the data obtained from the odor tests (Table 6), the inventive formulation has a lower odor test value as recorded unanimously by all the three panelists. Thus, it may be concluded that the odor reducing additives having functionalized mordenite particles (silicate particles) have improved performance for odor reduction as compared to compositions, which do not have functionalized mordenite (CR2) or compositions, which contain only a neat polymer (CR2). In other words, polymer compositions having functionalized silicate particles as has been described in this disclosure, demonstrate reduced odor characteristics and are particularly suitable for many industrial applications, which demand such reduced odor characteristics.

1. A polymer composition, comprising:
a. a plurality of functionalized silicate particles, wherein each of the plurality of functionalized silicate particles is functionalized by a grafting compound; and
b. a polymer component, wherein the plurality of functionalized silicate particles are dispersed in the polymer component.

2. The polymer composition of claim 1, wherein the functionalized silicate particle is selected from the group consisting of phyllosilicates, tectosilicates, nesosilicates, sorosilicates, cyclosilicates, inosilicates or combinations thereof.

3. The polymer composition of claim 1, wherein each of the plurality of functionalized silicate particle is a phyllosilicate or a tectosilicate selected from kaolins, micas, smectites, hormites, zeolites or combinations thereof.

4. The polymer composition of claim 1, wherein each of the plurality of functionalized silicate particle is a zeolite particle selected from mordenite, clinoptilolite, chabazite or combinations thereof.

5. The polymer composition of claim 1, wherein each of the plurality of functionalized silicate particles is functionalized by at least one functional group capable of reacting with one or more odor active compound and forming a condensate reaction product.

6. The polymer composition of claim 1, wherein the grafting compound is selected from aminosilane compounds, mercaptosilane compounds, carboxylated silane compounds, epoxy silane compounds, amine compounds, thiol compounds, organic acid compounds or combination thereof.

7. The polymer composition of claim 1, wherein the grafting compound is an aminosilane compound selected from (3-aminopropyl) triethoxysilane.

8. The polymer composition of claim 1, wherein the polymer component is selected from a thermoplastic polymer, a thermoset polymer, an elastomeric polymer or combinations thereof.

9. The polymer composition of claim 1, wherein the polymer component is selected from polypropylene (PP), polyethylene (PE), polyester, polycarbonate (PC), polyetherimide (PEI), polyethyleneimine, styrene-acrylonitrile resin (SAN), polyvinyl chloride (PVC), epoxy polymers, polyether ether ketone (PEEK), poly(phenylene oxide) (PPO), polyether ketone ketone (PEKK), polysulfone sulfonate (PSS), polyphenylene sulfide (PPS), sulfonates of polysulfones, thermoplastic elastomer (TPE), terephthalic acid (TPA) elastomers, acrylonitrile butyldiene styrene (ABS), poly(methyl methacrylate) (PMMA), blend of polycarbonate and polybutylene terephthalate (PBT), blend of polycarbonate-acrylonitrile butadiene styrene (ABS), elastomeric block co-polymers, blend of polycarbonate-polyethylene terephthalate (PET), polyamide, polystyrene (PS) or combinations thereof.

10. The polymer composition of claim 1, wherein the plurality of functionalized silicate particles are present in an amount ranging from 0.01 wt. % to 65.0 wt. %, with regard to the total weight of the polymer composition.

11. The polymer composition of claim 1, wherein the polymer composition further comprises additives ranging from 0 wt. % to 55.0 wt. %, with regard to the total weight of the polymer composition.

12. The polymer composition of claim 1, wherein the polymer component is present in an amount ranging from 35.0 wt. % to 99.99 wt. %, with regard to the total weight of the polymer composition.

13. The polymer composition of claim 1, wherein each of the plurality of functionalized silicate particle contains a grafting compound present in amount ranging from 1 wt. % to 30 wt. %, with regard to the total weight of the functionalized silicate particle.

14. The polymer composition of claim 1, wherein each of the plurality of functionalized silicate particle has a surface area of at least 100 m²/g.

15. The polymer composition of claim 1, wherein each of the plurality of functionalized silicate particle has a surface area ranging from 110 m²/g to 1000 m²/g.

16. A process for preparing the polymer composition of claim 1, comprising:
a. providing a polymer component;
b. providing a plurality of functionalized silicate particles; and
c. compounding a mixture comprising the polymer component and the plurality of functionalized silicate particles and forming the polymer composition.

17. A process for preparing the polymer composition of claim 1, comprising:
a. dissolving a polymer binder component in a solvent and forming a polymer solution;
b. dispersing a plurality of functionalized silicate particles in a solvent and forming a silicate dispersion;
c. adding the silicate dispersion to the polymer solution at any temperature ranging between 10° C. to 500° C. and forming a masterbatch precursor;
d. subjecting the masterbatch precursor to precipitation conditions and obtaining a masterbatch comprising a plurality of functionalized silicate particles; and
e. compounding the masterbatch with a polymer component and obtaining the polymer composition.

18. An automobile component comprising the polymer composition of claim 1.

19. A polymeric article prepared by injection molding or by extruding the polymer composition of claim 1.

20. A polymer composition, comprising:
a. a plurality of functionalized zeolite particles present in an amount ranging from 0.01 wt. % to 65.0 wt. % with regard to the total weight of the polymer composition, wherein each of the plurality of zeolite particles is functionalized by an aminosilane compound containing at least one amine functional group; and
b. a thermoplastic polymer component present in an amount ranging from 35.0 wt. % to 99.99 wt. %, with regard to the total weight of the polymer composition, wherein the plurality of functionalized zeolite particles are dispersed in the thermoplastic polymer component.
